(19) United States
(12) Patent Application Publication
(10) Pub. No.: US 2006/0127194 A1
(43) Pub. Date: Jun. 15, 2006

(54) Machining tool for chip removal

(75) Inventor: Hans Schafer, Gomaringen (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Hartmetall-Werkzeugfabrik Paul Horm GmbH, Tubingen (DE)

(21) Appl. No.: 10/523,817

(22) PCT Filed: May 22, 2003
(86) PCT No.: PCT/EP03/05344

§ 371 Date: Sep. 14, 2005

(30) Foreign Application Priority Data
Aug. 17, 2002 (DE) 102 37 772.3

(51) Int. Cl. B23B 51/00

(52) U.S. Cl. 408/231

(57) ABSTRACT

The invention concerns a machining tool for chip removal, in particular a milling cutter, comprising a support (10) wherein is provided a housing (12) for a cutting element (14) equipped with a machining part (16) and a fixing part (18). The fixing part (18) includes a base part (20) which is placed in the housing (12) in receiving position (22) and which, when it its rotated into interlocking position (26) meshes beneath at least one retaining flange (26) of the housing (12), being thereby capable of being used with the cutting element (14) for chip removal matching. It is therefore possible to fix said cutting element without additional retaining means, such as a fixing screw or the like, its simple insertion into the housing and its interlocking position by rotation providing a reliable fixing method. Conversely, said cutting element can be released from its interlocked position and extracted from the housing hardly with very little force.

The invention relates to a machining tool for chip removal, a milling tool in particular, having a holder wherein there is provided a tool carrier for a cutting element which has a machining part and a fastening part.

Tools such as these are readily obtainable on the market in a plurality of embodiments and in the known designs there are various possibilities for interchangeably fastening the cutting element which consists preferably of carbide material which is subject to wear during machining, on a holder. Thus German Patent DE 34 48 086 C2 discloses putting an annular cutting element which is provided radially on its outside circumference with a machining edge by way of three crown-shaped ribs, which are diametrically opposite one another and which are located on its bottom, in correspondingly configured fastening grooves which widen conically to the outside on the end side of the holder in order to fix the cutting element in this way on the holder by way of a conical fastening screw, which on the end side extends through the center recess of the cutting element. The approach here allows moment-free support of the cutting element on the holder in machining with the machining edge. The initiation of harmful vibrations which may adversely affect machining is also largely precluded in this way. The known tool in question is generally used for machining of internal recesses. The fastening process by means of a fastening screw is disadvantageous since it must be loosened and retightened each time for the process of replacing the cutting element. Consequently, this replacement process requires some time for the fastening process in the scope indicated.

DE 195 22 452 C1 discloses a milling tool, especially a circular miller, with a shaft part which may turn along an axis of rotation, and a head part on which there is at least one machining edge on the circumferential side, the shaft and head part being connected to one another torsion-proof by fitting into one another by way of engagement means of one part which precisely adjusted engage the assigned recesses of the other part with contact along driver surfaces. The respective engagement means along its outer circumference has a centering surface, which undergoes transition in the direction of the axis of rotation of the tool into the driver surface, which together with the centering surface is encompassed by the respectively assigned recess and is bordered on the circumferential side by the shaft or head part. The known approach accordingly relates to a versatile milling tool, which has a very space-saving antirotation means, the respective machining edge designed to be interchangeable, and with the known approach machining may be carried out without failures in a definable diameter range. To secure the head part on the shaft part, the head part is provided with three internally threaded holes, the respective hole axis having a slight offset relative to the corresponding internally threaded holes in the shaft part so that when the head part is secured with the respective machining edge by way of the corresponding engagement screws, the indicated offset is equalized and the indicated parts are fixed on one another by way of the respective centering surface of the engagement means with zero play for a machining process. This approach for the replacement process of the head part with cutting elements is very time-consuming and this approach is also complex with respect to the technical implementation.

PCT/WO 98/50187 discloses a metal-cutting tool in which a cutting element with a carbide material machining edge has a middle centering recess into which a mounting rod may be inserted in the fixed state by way of the head part located on the end side, the rod's fastening the cutting element with the center recess by way of conically arranged centering surfaces into the corresponding recesses on the free end of the assignable holder in a torsion-proof and axially secured manner. Here the pertinent fastening rod is pressed against a compression spring, which is located in the holder with its other opposing end for the fastening process of the cutting element and as soon as the fixed position for the cutting element is reached, by way of a set screw, which extends through a widening of the holder at an oblique angle, the fastening rod is secured in the holder by the set screw being pressed by tightening against the groove of the fastening rod located on the outer circumferential side. As a result of the plurality of parts, this known approach is complex and consequently expensive to implement and several handling processes must be combined with one another for the fastening process, such as actuating the set screw, adjusting the fastening rod, and pressing it against a compression spring located in the holder during the installation process. In this respect, the process of replacing the cutting element with the machining edge is also time-consuming and requires an extensive installation effort.

On the basis of this state of the art, the object of the invention is to further improve the known tool such that the process of replacing the cutting element may proceed promptly and as intended and that the advantages in the prior art are maintained, such as reliable delivery of the machining forces during metal cutting to the holder in order in such a way to ensure high machining accuracy. This object is achieved by a tool with the features of claim 1 in its entirety.

In that, as specified in the characterizing part of claim 1, the fastening part has a base part which may be inserted into the tool carrier in a receiving position and which when turned into the locking position extends under at least one holding projection in the tool carrier in order to be usable for metal cutting with the cutting element in this way, the process of fastening the cutting element is possible without any further fastening means such as a fastening screw or the like and simply inserting the cutting element into the tool carrier and turning into its locking position reliably initiates a fastening process and in the reverse sequence the assumed locking position may also be released again with low actuating forces in order to remove the cutting element from the tool carrier. In the locking position the machining forces, which occur during machining may also be reliably diverted into the holder by way of the cutting element. The described tool is especially suited in the configuration of a milling tool in which the holder is driven by way of a corresponding machine, such as a machine tool or drilling machine; but machining is also conceivable in which the tool is stationary and for the purposes of rotational machining the workpiece is moved rotationally relative to the tool.

In one preferred embodiment of the tool as claimed in the invention, the tool carrier on the end side has a receiving channel which extends transversely to the longitudinal axis of the holder and which may be penetrated by at least one locking piece of the base part, the receiving channel on the edge side being bordered by the respective holding projection under which the respective locking piece may extend in the locking position. By extending under the holding projections in the described manner, viewed in the axial direction, that is, in the longitudinal direction of the holder, the cutting element is securely held in the tool carrier so that even in so-called rear machining, that is, in the opposite feed direction, the cutting element remains securely held in the tool carrier.

In another, especially preferred embodiment of the tool as claimed in the invention, the receiving channel on the end side leads into a receiving cone which widens toward the exterior and which may be brought into contact with a correspondingly configured centering cone of the fastening part in the locking position of the cutting element. If the base part of the fastening part is turned into its locking position, the base part pulls the centering cone of the fastening part of the cutting element onto the receiving cone to which the receiving channel leads, and on the outer circumferential side to the cutting element its secure contact with the holder in its longitudinal axis is thereby attained.

By preference, provision is furthermore made such that the centering cone is adjoined by the machining part with at least one machining edge, preferably a triple-edged cutting plate, and that between the centering cone and the machining edge there is a connecting part which is pulled in the longitudinal axis of the holder in the locking position of the cutting element against the outer circumferential edge of the receiving cone. But here contact with the outer circumferential edge does not take place, rather centering takes place by way of the conically adjoining contact surfaces; this allows accurate adjustment of the cutting element on the end side of the holder.

In one especially preferred embodiment of the tool as claimed in the invention, on the base part there are two locking pieces which are diametrically opposite one another, located on the free end of the fastening part, with the locking pieces being connected to the centering cone which widens toward the exterior by way of a fastening shaft. During the fastening process, the centering cone is pulled against the contact cone of the holder by way of the pertinent locking pieces on the base part. Preferably this is additionally supported by the respective locking piece on its side adjacent to the centering cone being provided with a bevel which slopes down in the direction of the free end of the fastening part. This bevel supports the described process of drawing into the receiving cone of the holder.

In another preferred embodiment of the tool as claimed in the invention, within the tool carrier assigned to each locking piece there is a part of the thread with a lead which is oriented, beginning on the holding projection, in the direction of the inside wall of the tool carrier, which wall is closed on the end side. By way of the pertinent thread part, the fastening process of the cutting element on the holder takes place in the manner of a screwing-in motion and in this way an increased tightening moment on the respective locking piece is produced.

If in one preferred embodiment of the tool as claimed in the invention, one of the two locking pieces is designed to be radially shorter than the other, the slotted receiving channel having one correspondingly longer and one shorter receiving flank, it is ensured that the tool may be moved into the receiving channel for a locking process only in one receiving position. This may be of importance in particular when the cutting element is provided with only one machining edge and for mass equalization the pertinent cutting element must then assume a defined fastening position relative to the holder.

The described tightening process is further supported in that the axial length of the fastening shaft of the cutting element is at least greater than the length of the diametrically opposite holding projections on the holder, which length is measured in the longitudinal axis of the holder.

The tool as claimed in the invention is described in greater detail below using one embodiment illustrated in the drawings.

The figures are schematic and in part not to scale.

FIG. 1 shows in an oblique view the end side of the tool with the cutting element and holder,

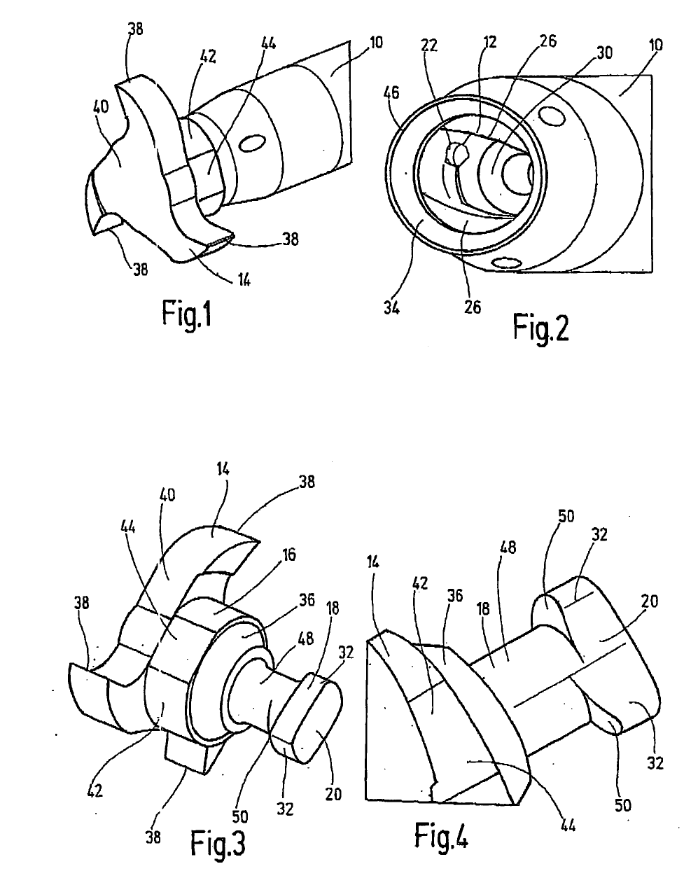

FIG. 2 shows an end view of the holder without the cutting element;

FIG. 3 shows in a perspective view the rear of the cutting element;

FIG. 4 shows in a perspective front view the base part of the cutting element as shown in FIG. 3;

FIG. 5 shows, enlarged by a factor of 10, the end top view of the front side of the holder as shown in FIG. 2;

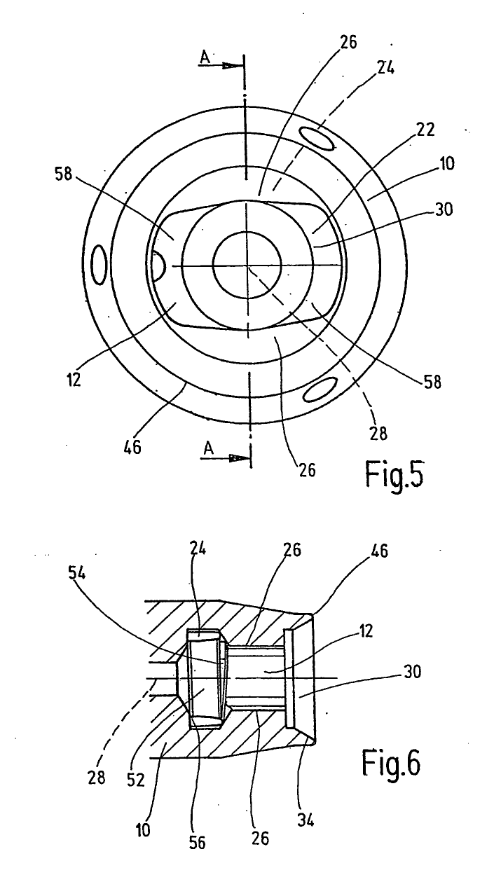

FIG. 6 shows a section along line A-A as shown in FIG. 5.

The tool which is shown in the figures is used for metal cutting and represents in particular a milling tool with which, depending on the machining and cutting edge geometry, internal recesses in metal workpieces or the like may be produced. The tool is provided with an oblong holder 10 for fastening the tool on a metal cutting machine, for example in the form of a machine tool or the like. As FIG. 2 in particular shows, the holder on its one free end has a tool carrier 12 for holding the cutting element 14. The cutting element 14 has a machining part 16 and a fastening part 18 (cf. FIG. 3). The fastening part 18 has a base part 20 which may be inserted into the tool carrier 12 in the holding position (cf. FIG. 5). If the base part 20 is turned into the locking position 24, that is, clockwise, the base part 20 extends under two diametrically opposite holding projections 26 in the tool carrier 12 in order in this way to be usable for metal cutting.

As shown especially in FIGS. 2 and 5, the tool carrier 12 on the end side extending transversely to the longitudinal axis 28 of the holder 12 has a receiving channel 30 in the manner of a transverse slot. This receiving channel 30 may be penetrated by at least one locking piece 32 of the base part 20, in the illustrated embodiment there being two diametrically opposite locking pieces 32 on the base part 20 of the cutting element 14. The receiving channel 30 on the edge side is bordered by the respective holding projection 26 under which the respectively assigned locking piece 32 extends in the locking position 24 of the cutting element 14. As FIGS. 2 and 6 show further, the receiving channel 30 on the end side leads into the open by way of a receiving cone 34 which widens toward the exterior and which may be moved into contact with the correspondingly configured centering cone 36 of the fastening part 18 in the locking position 24 of the cutting element 14.

The centering cone 36 adjoins the machining part 16 with at least one machining edge 38 preferably in the form of a conventional triple-edged cutting plate 40. Here, between the centering cone 36 and the respective machining edge 38, there is an at least partially cylindrical connecting part 42 which may be provided with a handle 44 for holding a conventional fastening tool, for example in the form of a hexagonal wrench or the like. Accordingly, the points which form the handle 44 are flattened relative to the other cylindrical parts of the connecting part 42. But preferably it is provided that the cutting element 14 be interchangeably inserted into the holder 10 by hand by taking hold at the location of the triple-edged cutting plate 40, with the pertinent fastening and replacement process being detailed below.

The connecting part 42, which extends in the longitudinal axis 28 of the holder 10, is pulled in the fastening process of the cutting element 14 and consequently in the direction of the locking position 24 of the cutting element 14 against the outer circumferential edge 46 of the receiving cone 34. From the outer circumferential edge 46 of the holder 10 to the outside it likewise widens conically until it undergoes transition into the cylindrical shaft part of the holder 10. Since contact takes place exclusively by way of the receiving cone 34 and the assigned centering cone 36, in the direction of the longitudinal axis 28 of the holder there is a distance, even though short, of the connecting part 42 relative to the outer circumferential edge 46 of the holder 10.

As furthermore is to be seen from FIGS. 3 and 4, the two diametrically opposite locking pieces 32 are located on the free end of the fastening part 18 and are connected by way of a fastening shaft 48 to the centering cone 36 which widens towards the exterior at a definable axial distance. The respective locking piece 32 on its side adjacent to the centering cone 36 is provided with a bevel 50 which slopes down in the direction of the free end of the fastening part 18 to the outside at a flat angle. Furthermore, as shown especially in FIG. 4, the bevels 50 may begin at different distances to the centering cone 36 on the fastening shaft 48, as they extend subsequently under the holding projections 26 in order thus to apply a tightening moment to the respective cone 34, 36. Preferably provision is made here for the fact that in the interior 52 of the tool carrier 12, assigned to each locking piece 32, at least one thread 54 is assigned with a lead beginning on the holding projection 26, which lead is oriented in the direction of the inside wall 56 of the tool carrier 12, which wall is at least partially closed on the end side (cf. FIG. 6).

For the fastening process, the cutting element 14 with its two locking pieces 32 is inserted into the tool carrier 12 such that the two locking pieces 32 extend through the two flanks 58 of the receiving channel 30 (cf. FIG. 5). The centering cone 36 of the cutting element 14 is then pressed against the receiving cone 34 of the holder 10 by way of the triple-edged cutting plate 40, and when contact is made, the cutting element 14 is turned clockwise by a definable swiveling path of the cutting element relative to the holder 10. As a result, the two locking pieces 32 engage the respective thread 54 assigned to them and are secured by extending in the locking position under the holding projections 26 which located transversely to the receiving channel 30 border it to the exterior. For reliable delivery of force and moment during machining, the cutting element 14 by way of its centering cone 36 then adjoins the holder 10, and also by way of the two locking pieces 32, in the area of their bevels 50. For the replacement process the described fastening process must be carried out in the reverse sequence and after removing the cutting element 14 from the tool carrier 12 of the holder 10 it may be replaced by a new cutting element 14.

In an embodiment of the tool as claimed in the invention which is not detailed, provision may be made such that one of the two locking pieces 32 is designed to be radially shorter than the other, with the slotted receiving channel 30 having one accordingly longer and one shorter receiving flank 58. In this way it is then possible to implement the fastening and loosening process in only one position; this may be of importance when the machining fixture is provided for example with only one machining edge (not shown).

1. A machining tool for chip removal, a milling tool in particular, having a holder (10) wherein there is provided a tool carrier (12) for a cutting element (14) which has a machining part (16) and a fastening part (18), characterized in that the fastening part (18) has a base part (20) which may be inserted into the tool carrier (12) in a receiving position (22) and which when turned into the locking position (26) extends under at least one holding projection (26) in the tool carrier (12) in order thereby to be usable for metal cutting with the cutting element (14).

2. The tool as claimed in claim 1, wherein the tool carrier (12) on the end side has a receiving channel (30) which extends transversely to the longitudinal axis (28) of the holder (10) and which may be penetrated by at least one locking piece (32) of the base part (20), and wherein the receiving channel (30) on the edge side is bordered by the respective holding projection (26) under which the respective locking piece (32) may extend in the locking position (24).

3. The tool as claimed in claim 2, wherein the receiving channel (30) on the end side leads into a receiving cone (34) which widens toward the exterior and which may be brought into contact with a correspondingly configured centering cone (36) of the fastening part (18) in the locking position (24) of the cutting element (14).

4. The tool as claimed in claim 3, wherein the centering cone (36) is adjoined by the machining part (16) with at least one machining edge (38), preferably a triple-edged cutting plate (40), and wherein between the centering cone (36) and the machining edge (38) there is a connecting part (42) which is pulled in the longitudinal axis (28) of the holder (10) in the locking position (24) of the cutting element (14) against the outer circumferential edge (46) of the receiving cone (34).

5. The tool as claimed in claim 2, wherein on the base part (20) there are two locking pieces (32) which are diametrically opposite one another and wherein, located on the free end of the fastening part (18), the locking pieces are connected to the centering cone (36) which widens toward exterior by way of a fastening shaft (48).

6. The tool as claimed in claim 2, wherein the respective locking piece (32) on its side adjacent to the centering cone (36) is provided with a bevel (50) which slopes down in the direction of the free end of the fastening part (18).

7. The tool as claimed in claim 2, wherein in the interior (52) of the tool carrier (12) assigned to each locking piece (32) there is at least one part of a thread (54) with a lead beginning on the holding projection (26), which lead is oriented in the direction of the inside wall (56) of the tool carrier (12), which wall is at least partially closed on the end side.

8. The tool as claimed in claim 5, wherein one of the two locking pieces (32) is designed to be radially shorter than the other and wherein the slotted receiving channel (30) has one correspondingly longer and one shorter receiving flank (58).

9. The tool as claimed in claim 1, wherein the cutting element (14) after insertion into the tool carrier (12) may be moved against the direction of machining of the respective machining edge (38) into its locking position (24) and in the opposite direction of rotation into a receiving position (22).

10. The tool as claimed in claim 5, wherein the axial length of the fastening shaft (48) is at least greater than the length of the diametrically opposite holding projections (26), especially relative to their bevels (50), which length is measured in the longitudinal axis (28) of the holder (10).
